(19) United States
(12) Patent Application Publication
(10) Pub. No.: US 2026/0336930 A1
(43) Pub. Date: Oct. 29, 2026

(54) STORAGE FACILITY WITHOUT LIFTS

(71) Applicant: Dematic GmbH, Heusenstamm (DE)

(72) Inventors: Daniel Huberth, Aschaffenburg (DE); Shin Yamashita, Singapore (SG)

(21) Appl. No.: 19/107,342

(22) PCT Filed: Sep. 6, 2022
(86) PCT No.: PCT/EP2022/074697

§ 371 Date: Feb. 27, 2025

(51) Int. Cl. B65G 1/04; B65G 1/137

(52) U.S. Cl. CPC B65G 1/0492; B65G 1/1378

(57) ABSTRACT

A storage facility having storage racks and rack levels for storage of load-units, wherein two storage racks have an aisle between them, each rack level having running rails on the opposing faces of the storage racks, on which at least one storage/retrieval apparatus may travel the length of the aisle, for each aisle climbing rails on the opposing faces of the storage racks adjacent the respective aisle); the storage/retrieval apparatus having an area located between unit-handler that may extend into the storage racks perpendicular to aisle, for placing/retrieval of load-units into/from the storage racks, each storage/retrieval apparatus having wheels for traveling along the running rails horizontally along the respective rack level of an aisle; one or both of each side being driven on a joint driven axis, wherein each storage/retrieval apparatus has a climber for vertical movement so as to achieve a three-dimensional movement of the storage/retrieval apparatus.

### CROSS REFERENCE TO RELATED APPLICATION

The present application is a national stage application of International Patent Application No. PCT/EP2022/074697, filed Sep. 6, 2022.

### TECHNICAL FIELD AND BACKGROUND

The present disclosure relates to a storage facility.

When picking or compiling orders from ready-picked transport units, such as e. g. articles or containers, it is necessary to provide the transport units, which are associated with a common order, in a targeted or sorted manner. For this purpose, it is typical to temporarily store (buffer) the transport units of one order until all of the transport units required for the order are present. They are then passed collectively onto a collecting line which guides them e. g. to the palletization area, picking station, goods issuing department, dispatch etc.

A (high) rack storage facility includes a feeding or storage-entry area, via which the goods are delivered and from which the racking serving units collect the goods for entry into storage, the so-called pre-zone. Similarly, a retrieval-from-storage area is required, at which after retrieval from storage the racking serving units place down the goods also assigned to the pre-zone. In the case of automatic picking warehouses, picking points are typically arranged in the pre-zone. The pre-zone is also where the goods are identified for the inventory management system or the material flow computer.

The applicant's EP 1 964 792 B1 discloses a method for providing transport units from a storage facility in a desired sequence on at least one collecting line. Racking serving units in each storage racking aisle, retrieval-from-storage lifts and retrieval-from-storage feeding lines are controlled so as to be coordinated with one another and are loaded with goods such that they ultimately end up sorted on the collecting line or are delivered thereby.

The control and coordination are therefore relatively complex and obviously require technical installations in the so-called pre-zone, i. e. the area outside the actual racking.

U.S. Pat. No. 9,452,886 B2 discloses exchange of transporting units directly between adjoining storage racks from one access aisle to a specific aisle via transverse conveyance locations in the storage racks themselves, wherein the storage and retrieval vehicle comprises a shuttle at each level of the storage racks, wherein the directly exchanging comprises the shuttle acting on the transport units to displace the transport units by contact with the shuttle in the transverse conveyance locations from one of the adjoining racks to the other of the adjoining racks including transferring product transport units to the specific aisle using the transverse locations.

However, lifts are in contrast to shuttles the bottleneck in such systems.

DE 20 2004 012 021 U1 discloses a storage system that has at least one conveyor with a horizontal transporting unit and executing vertical or vertical and horizontal movements between two shelf columns installed one behind the other. The storage system has at least one row of more than two shelf columns placed one behind the other and separated from one another by respective feed shaft equipped with a conveyor. Though each of the conveyors are movable on both sides of each shelf column, all the compartments of these shelf columns can be directly loaded or emptied.

EP 3 609 814 B1 discloses an order-picking system comprising self-guided carriages that run along the floor of the warehouse and are also able to climb the face of a rack. For which the carriages have at least two rolling wheels and motorized climbing means formed by gearwheel carriers capable of interacting with two pairs of posts so as to allow the carriage to move up along the posts. A roller chain is attached to each of the posts and extends parallel to the longitudinal axis of the post to which it is attached and is intended to receive the gearwheel cooperating with the post to which it is attached, and each movable support has means for rigidly connecting to one of said four posts in order to maintain a predetermined distance between the axis of the gearwheel and the chain. This system is complex as the chain may move.

### SUMMARY

In contrast thereto, the disclosure provides a storage facility in a fashion that alleviates the bottleneck created by lifts and at the same time allows for an efficient handling of storage units in the racks.

In accordance with the disclosure, it has been recognized that if each storage and retrieval apparatus has climber for vertical movement, especially along the vertical climbing rails, it is possible to achieve high storage density with good access rates without necessity for dedicated lifts. Additionally, the disclosure provides scalability and flexibility, as the number of storage and retrieval apparatus (e. g. shuttles) can be easily adjusted depending on throughput needs and/or size of the storage.

It is even possible to upgrade a conventional system at a later stage allowing to refurbish existing storages by adding the vertical movement and e. g., vertical climbing rails in the end zones of conventional racks. This could be done by replacing lifts with climbing rails or installing the climbing rails in the original lift frame.

The vertical climbing rails can, for example, be installed instead of or in addition to a conventional lift. It should be understood that more than one climbing rails section may be present in a racking. These can be arranged at the end sections of the aisles, but also in the middle section, which has throughput benefits for longer aisles.

The system can handle a wide variety of load carrying units, e. g. totes, trays or cartons.

Further advantages may include that orders can be consolidated within the storage rack simplifying ground or conveyor based traffic outside of the racking, as the storage and retrieval apparatus does not need to leave an aisle to change storage levels.

Accordingly, sequencing and buffering of load carrying units is possible on every level. The disclosure implements an easy roaming principle without additional equipment and without any height restriction.

A system according to the disclosure has almost no single point of failure. It does need to have a dedicated lift for totes etc., bots, shuttles or the like.

In one embodiment, the climber of the storage and retrieval apparatus includes a set of four climbing wheels for interaction with the vertical climbing rails, the four climbing wheels having a perpendicular axis of movement in comparison to the four travelling wheels and the four climbing wheels being retractable between an extended engaging position for interaction with the vertical climbing rails and a retracted non-engaging position while travelling horizontally along the running rails horizontally along the respective storage rack level. Such climbing wheels can be retrofitted to known storage and retrieval apparatus.

Each storage and retrieval apparatus may have a second set of four or more retractable traveling wheels for traveling along direction change rails horizontally along the respective storage rack level of an aisle in the area of the vertical climbing rails; two wheels per set on each side of the storage and retrieval apparatus, one or both of each side being driven, e. g., on a joint driven axis, for use while changing the direction of movement of the storage and retrieval apparatus from a vertical movement along the vertical climbing rails to a horizontal movement along the running rails of a respective storage rack level of an aisle.

The four traveling wheels for traveling along direction change rails horizontally along the respective storage rack level of an aisle in the area of the vertical rails are preferably retractable wheels and are controlled to be extracted or extended to the use position whilst the storage and retrieval apparatus is traveling along the direction change rails. Their position on the storage and retrieval apparatus is such that their distance and placement allows interaction with the direction change rails when changing direction of travel.

Direction change rails may be arranged between the vertical climbing rails on each level having running rails and the running rails of a respective storage rack level of an aisle may then have a gap to the direction change rails horizontally along the respective storage rack level of an aisle in the area of the respective vertical rail. This allows an easy and smooth change of direction from vertical to horizontal movement (or vice versa).

So essentially, the storage and retrieval apparatus would climb up the vertical climbing rails by use of its extended climbing wheels. As soon as it reaches its destination level, the traveling wheels for traveling along direction change rails are extended to engage the direction change rails. The climbing wheels can then be retracted. The storage and retrieval apparatus will travel horizontally along these rails (just a few centimeters) until the first set of four traveling wheels for traveling along the running rails horizontally engage the horizontal aisle running rails, whereas the auxiliary traveling wheels for traveling along direction change rails loose traction and may be retracted.

Beneficially, the running rails and the direction change rails are aligned with each other. Optionally, they both have a C-shaped cross section, of which the top surface forms support for the first set traveling wheels and the inner lower surface forms a support for the second set of traveling wheels.

Additionally, it is possible to implement cross aisle running rails to form a bridge perpendicular to aisle direction for movement of each storage and retrieval apparatus between aisles, preferably propelled by the set of the four climbing wheels. Then it is even possible for the storage and retrieval apparatus to change aisles without leaving the racking.

In one possible embodiment, the climbing wheels are gear wheels (pinion) and the vertical rails and/or cross aisle running rails have corresponding linear gears (racks) or chains, with which a positive interaction occurs.

In an embodiment the gear wheels (pinion) may be implemented as self-locking (e. g. by self-weight of the storage and retrieval apparatus) so as to stop a storage and retrieval apparatus in the event of (a power) failure from uncontrolled vertical travel or crash. To do so the gear wheels may be attached by pivoting arms to the frame of the storage and retrieval apparatus such that it implements a wedge-like function.

Additionally, the gear wheels may be equipped with a mechanical failsafe brake, which would hold a storage and retrieval apparatus in a current position even if power or control is lost as long as pinions are locked.

It is also possible to use different climbers. For example, the climbing wheels could also be implemented as wheels that are pressed against vertical rails with enough force to produce a friction high enough to not slide downwards, even when the load carrying area is loaded.

The storage facility may include a direct horizontal exchange of load units taking place from one aisle to an adjacent aisle via exchange locations within the storage racks, wherein the storage and retrieval apparatus itself actively horizontally moves the transportation units in the exchange locations using the unit (or load) handlers, such as telescopic arms having engageable unit (or load) contacting means (i. e. rotatable or linear moveable fingers). In this way load units may be transferred from one aisle to the adjacent aisle on the shortest path, without need for them to leave an aisle or for the storage and retrieval apparatus to do so.

Optionally, the rack has an interface to conveyors of the pre-zone or front zone of a fulfilment area for connection to picking stations anywhere between the lowest level to highest level, preferable at least one per aisle. More than one per aisle is also possible. It is also possible but not limited to have more than one fulfilment area, e. g., on different levels, both separately connected in the described way to the rack.

In one embodiment, the storage rack may have at least one interface allowing hand over of unit loads to an AMR (Autonomous Mobile Robot) for further ground-based transportation. This allows hand over of unit loads for their transportation outside of the rack in a very flexible way, as the AMR are not bound to rails or predetermined routes. Such an interface may be present in at least one aisle and could be present in several aisles or every aisle.

The storage facility may also include a ground-based transportation AMR (AMR shuttle movers) allowing transportation of a storage and retrieval apparatus within the storage, optionally between aisles. This will allow to flexibly use the storage and retrieval apparatus within the whole rack, e. g., to deal with unbalanced retrieval volume in each aisle, and to scale the number of storage and retrieval apparatus as needed by the customer's throughput. For example, one may start with a few storage and retrieval apparatus not dedicated to aisles and use the disclosure for changing aisles. Later when throughput needs increase, more storage and retrieval apparatus can be installed and less change of aisles becomes necessary.

To increase storage capacity and density, the storage facility may include a storage and retrieval apparatus (stacker shuttle) implemented with a stacker to stack and unstackg unit loads, optionally containers or totes, on top of each other on its' carrying area. This allows for storing and possibly transport of stacked load units.

In addition, it is possible to include a conventional lift, which would be present in at least once within the system. This would allow conventional storage and retrieval apparatus to be used side-by-side with the dual direction travel storage and retrieval apparatus of the disclosure and/or increase vertical throughput of the system.

It is possible that more than one storage and retrieval apparatus be inducted into a single level of a storage rack aisle, thereby increasing throughput. Optionally, the number of storage and retrieval apparatus is linked to the length of an aisle. Usually, two storage and retrieval apparatus will suffice. The storage and retrieval apparatus would then have sensors and controls to negotiate travel area between the storage and retrieval apparatus on same level.

The disclosure allows a rescue operation of a broken-down storage and retrieval apparatus. A failed storage and retrieval apparatus (e. g. shuttle) can be rescued by pushing it to the rear end of the rack aisle by use of another storage and retrieval apparatus as long as the failed storage and retrieval apparatus does not have its unit handlers in a position extended into the storage racks.

The rescue operation is facilitated, if at least two climbing wheels of a set have bumpers facing the direction of movement along the aisle for contacting a respective pair of climbing wheels of a second storage and retrieval apparatus allowing a pushing operation. Alternatively or additionally, the front and/or back surface of the housing may be equipped with bumpers.

Optionally, each aisle has at least four pairs of vertical climbing rails on the opposing faces of the storage racks adjacent the respective aisle, so that the system may allow access from both sides of an aisle, depending on placement. It is also possible to use on set for upward and the other set for downward travel. This increases throughput and redundancy.

To perform onboard picking, at least one storage and retrieval apparatus may have an onboard robotic picking device. This may be used to pick items from load units without leaving the rack. The robotic picking device may include a vision system to identify items and allow a directional control of the gripping device of the robotic picking device.

The storage facility may also include a flow rack in at least one storage rack level.

It is known to implement onboard power supply, i. e. rechargeable batteries or high-capacity capacitors. If at least one of the vertical rails includes a power charging line adapted to connect to a power charging take-up on the storage and retrieval apparatus to allow charging of an onboard battery or capacitor of the storage and retrieval apparatus, it is possible to charge the storage and retrieval apparatus while climbing. These may also be charged using an onboard recuperation device connected to the climbing wheels to recover energy while moving downwards.

The storage facility according to the disclosure may additionally include a removable maintenance platform that is adapted to be brought into place for accessing the area between the vertical climbing rails. This allows access to a storage level where necessary, even in the area of the vertical climbing rails.

Additionally, the storage facility of the disclosure may include a triple deep storage rack reducing rack cost by 25% and increasing storage density by 25%. It is also possible to use stacked load units reducing rack storage cost by 25% and increasing density by 25%.

A beneficial use for the disclosure is in the area of vertical farming, in which the storage is used to stock living plants (https://en.wikipedia.org/wiki/Vertical farming).

The storage and retrieval apparatus could store and retrieve containers containing plants. These special containers (e. g. totes) of such an embodiment may be equipped with an insert frame with plant soil or other things. Therefore, the storage and retrieval apparatus would beneficially be implemented to be splash water protected.

Such an embodiment could also additionally include a modular and mobile plant treatment system for value added services (e. g. irrigation, insect protection treatment, fertilizer application etc.).

With such a modular and mobile plant treatment system including an application head and a pump operated supply tank a directed fine dosing is possible and the irrigation head can be moved to reach respective plants only, thus minimizing use of water etc. Such a tank may be filled manually or automatically on the lowest level, e. g. at a dedicated replenishment station, that would be implemented instead of or in addition to GTP stations.

A mixed operation of storage and retrieval apparatus loaded with plants and storage and retrieval apparatus loaded with the modular and mobile plant treatment system is possible.

### DETAILED DESCRIPTION OF THE DRAWINGS

Further features and details of the disclosure will be apparent from the description hereinafter of the drawing, in which

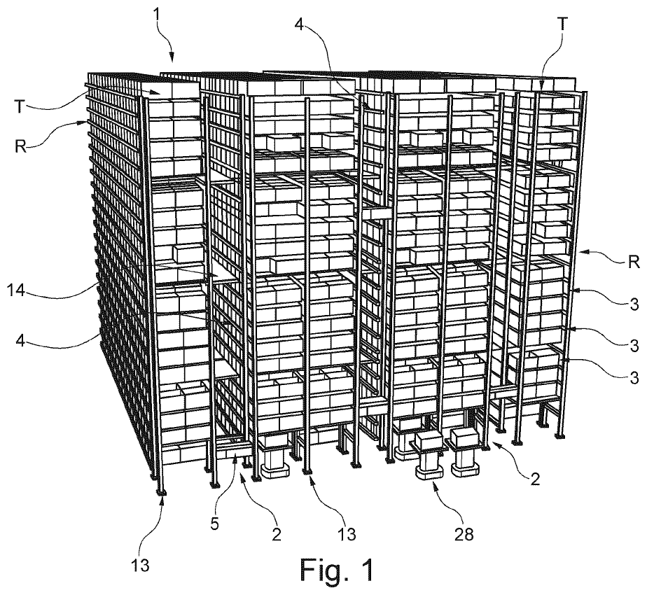

FIG. 1 shows a schematic perspective view of a storage rack according to a first embodiment of the disclosure;

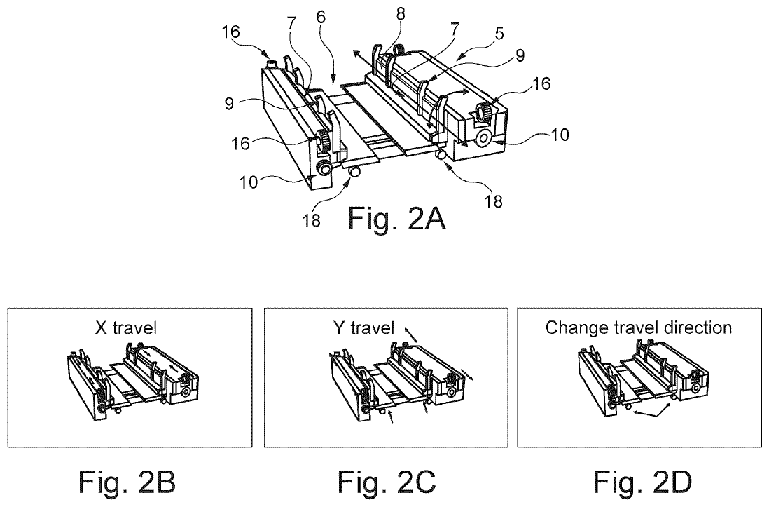

FIG. 2A shows details of the shuttle of FIG. 1;

FIG. 2B shows details of the shuttle of FIG. 1;

FIG. 2C shows details of the shuttle of FIG. 1;

FIG. 2D shows details of the shuttle of FIG. 1;

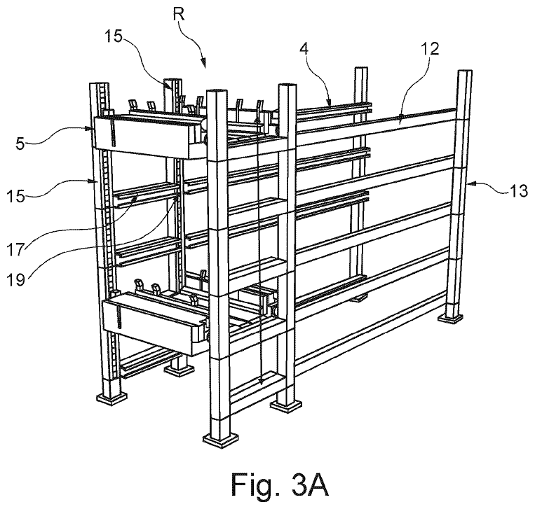

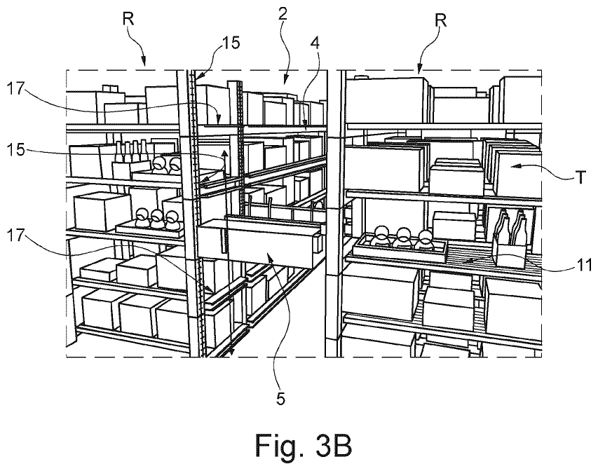

FIG. 3A shows details of vertical climbing rails in the rack;

FIG. 3B shows details of vertical climbing rails in the rack;

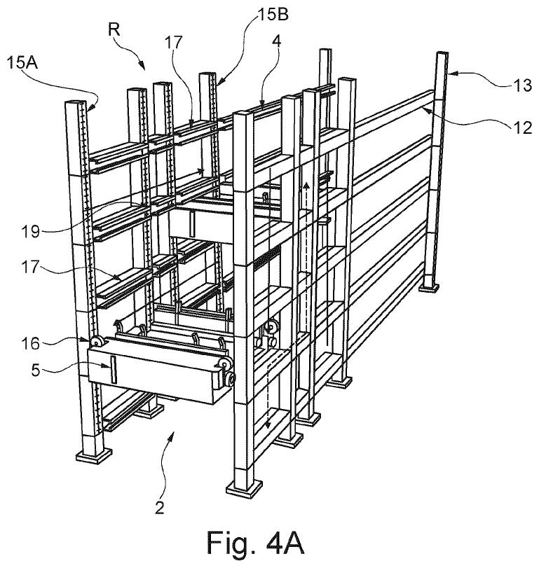

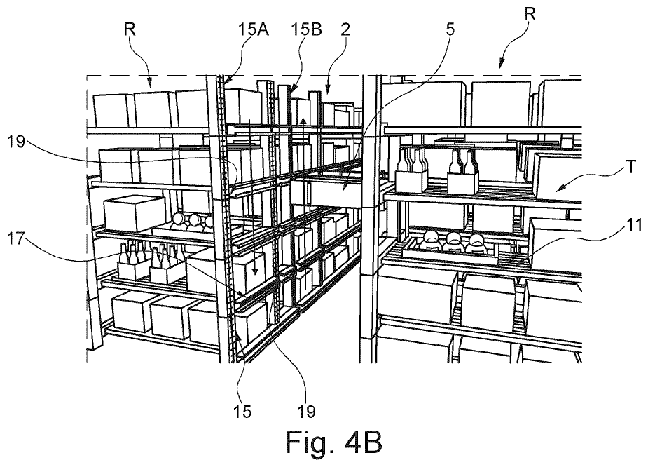

FIG. 4A shows an alternative to the implementation of FIG. 3;

FIG. 4B shows an alternative to the implementation of FIG. 3;

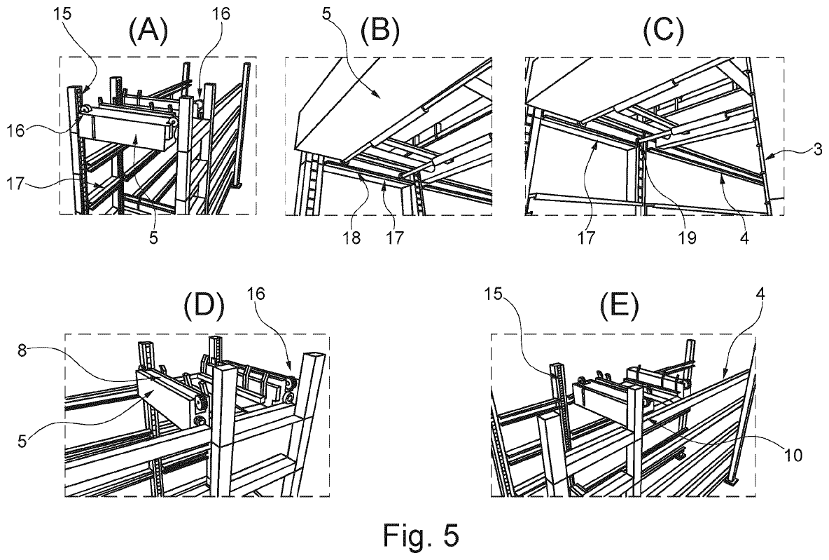

FIG. 5A shows details of travel direction change;

FIG. 5B shows details of travel direction change;

FIG. 5C shows details of travel direction change;

FIG. 5D shows details of travel direction change;

FIG. 5E shows details of travel direction change

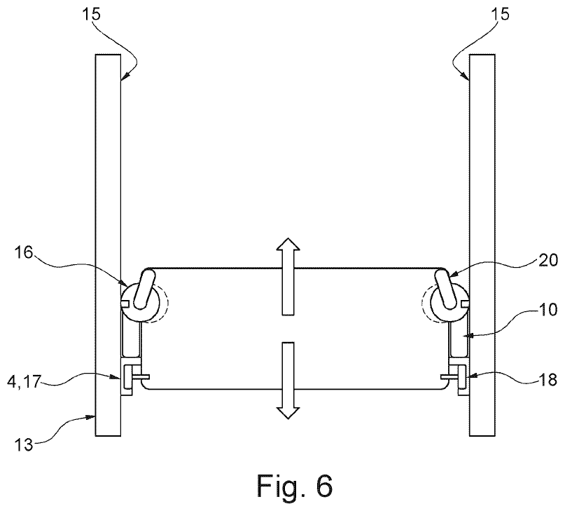

FIG. 6 shows a schematic implementation of a shuttle having “wedging arms”;

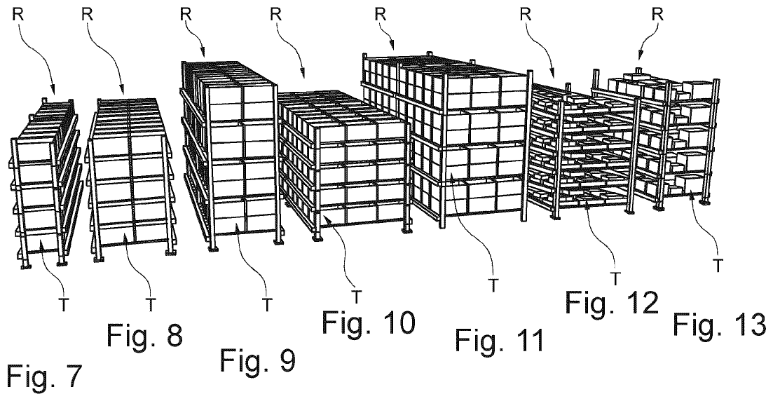

FIG. 7 show different rack configurations for use in the disclosure;

FIG. 8 shows different rack configurations for use in the disclosure;

FIG. 9 shows different rack configurations for use in the disclosure;

FIG. 10 shows different rack configurations for use in the disclosure;

FIG. 11 shows different rack configurations for use in the disclosure;

FIG. 12 shows different rack configurations for use in the disclosure;

FIG. 13 shows different rack configurations for use in the disclosure;

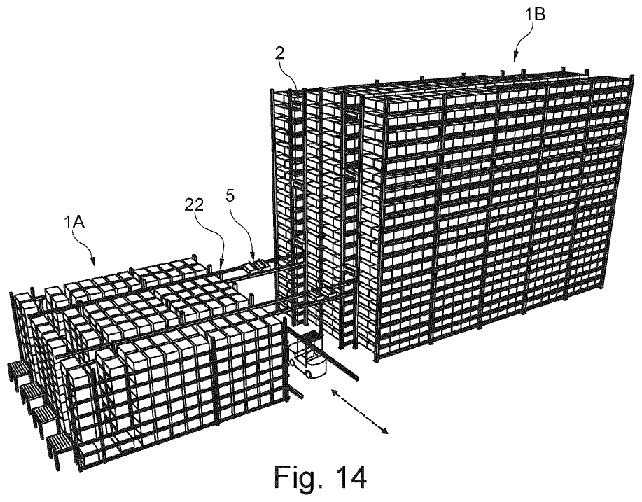

FIG. 14 show a possible configuration of a storage having two storage areas connected by a shuttle bridge;

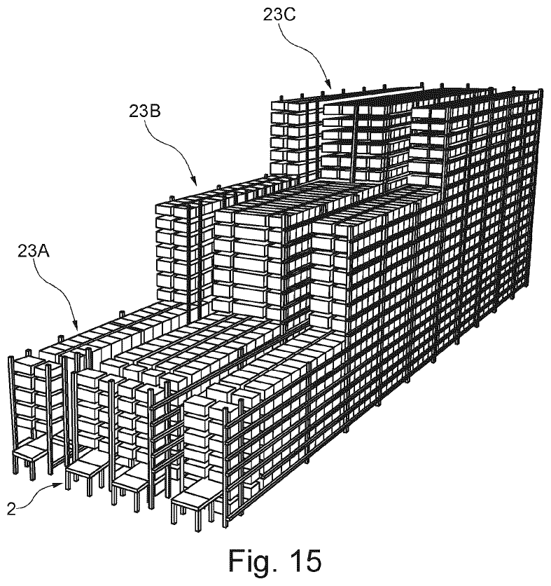

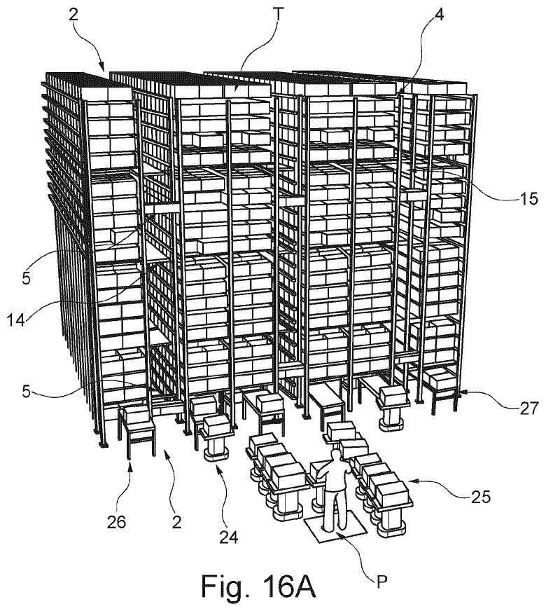

FIG. 15 show a possible configuration of a storage using racks with staggered heights;

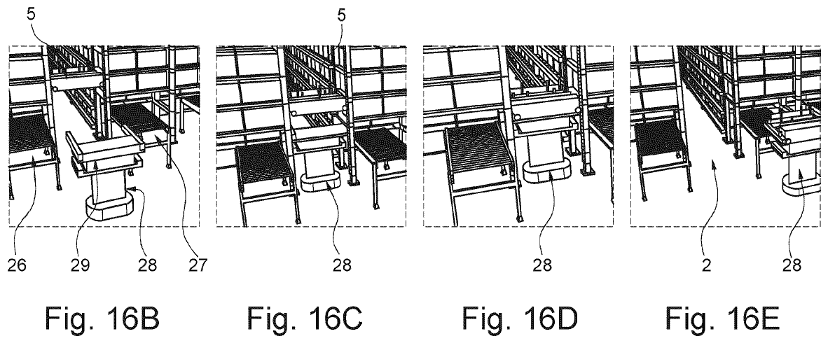

FIG. 16A shows an embodiment using AMR for transfer of a shuttle between aisles and also for ground-based transportation between a virtual GTP station and the storage racks;

FIG. 16B shows an embodiment using AMR for transfer of a shuttle between aisles and also for ground-based transportation between a virtual GTP station and the storage racks;

FIG. 16C shows an embodiment using AMR for transfer of a shuttle between aisles and also ground-based transportation between a virtual GTP station and the storage racks;

FIG. 16D shows an embodiment using AMR for transfer of a shuttle between aisles and also ground-based transportation between a virtual GTP station and the storage racks;

FIG. 16E shows an embodiment using AMR for transfer of a shuttle between aisles and also ground-based transportation between a virtual GTP station and the storage racks;

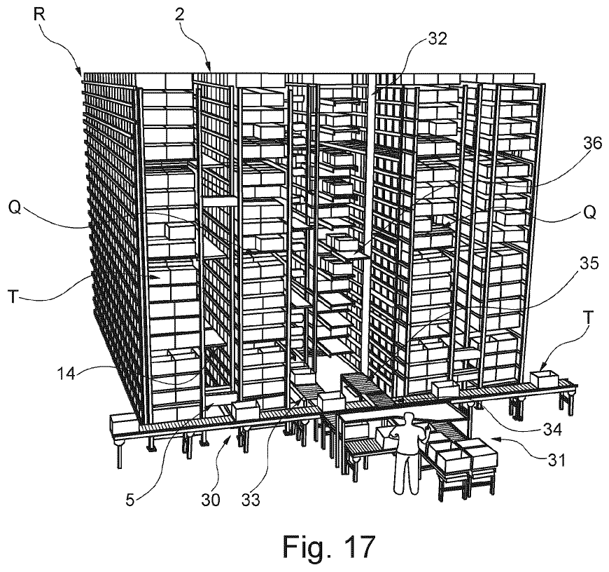

FIG. 17 shows an embodiment using conventional conveyors for container transport and a physical GTP station;

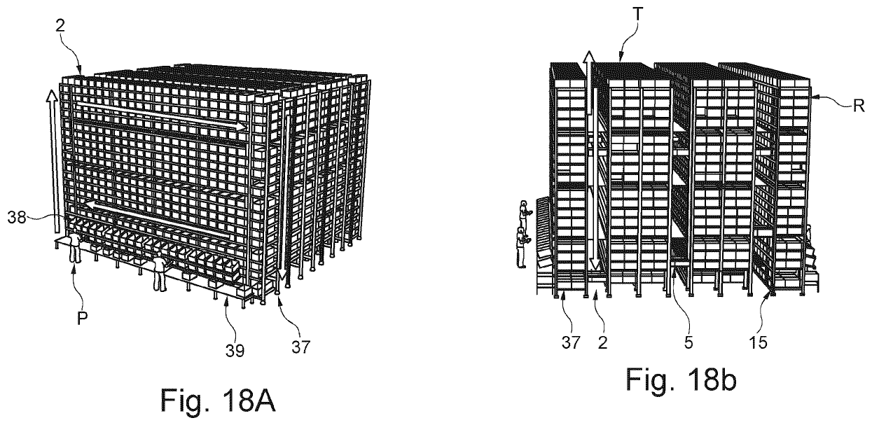

FIG. 18A shows an embodiment using a flow rack;

FIG. 18B shows an embodiment using a flow rack;

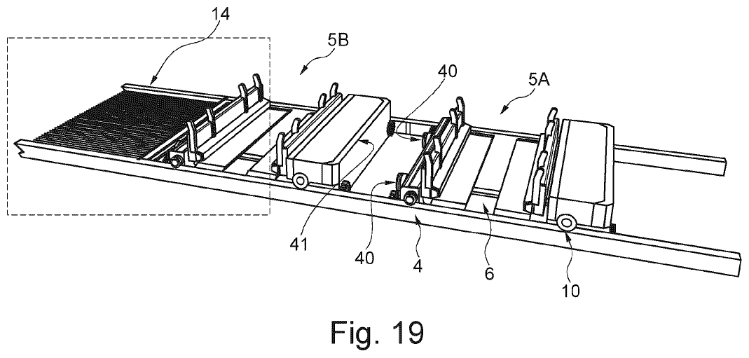

FIG. 19 shows a rescue operation of a shuttle;

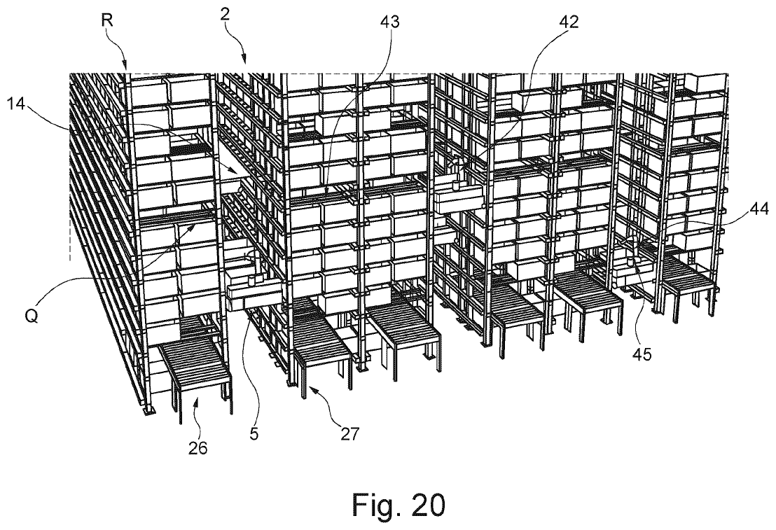

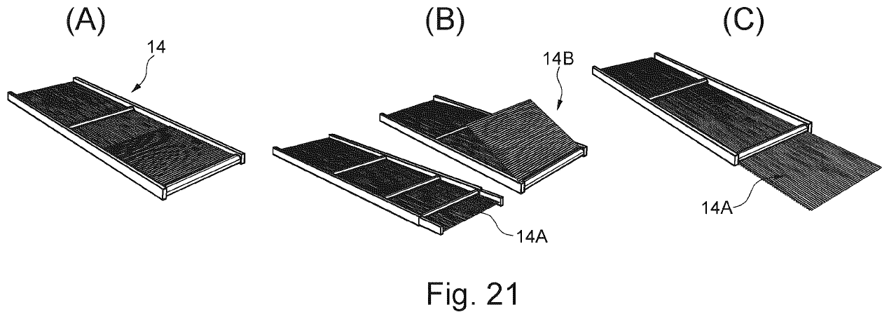

FIG. 20 shows an embodiment having transport shuttles and robotic picking shuttles as well as having cross aisle running rails forming a bridge;

FIG. 21 shows an implementation of a removable maintenance platform;

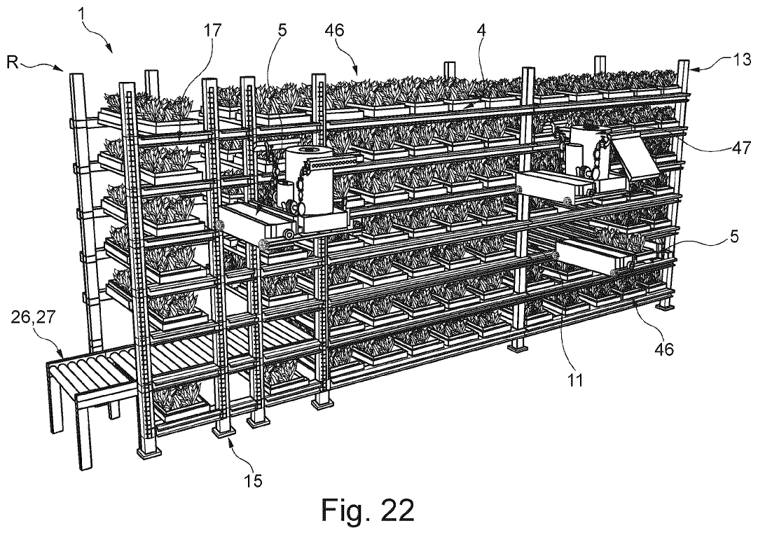

FIG. 22 shows an embodiment using the disclosure in the context of vertical farming;

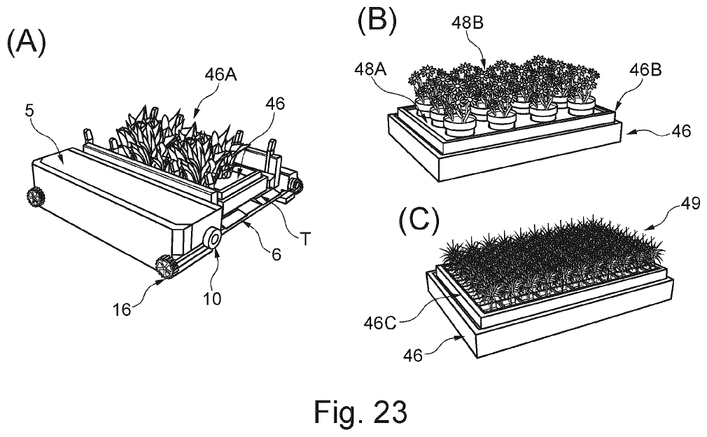

FIG. 23 shows an embodiment using the disclosure in the context of vertical farming; and

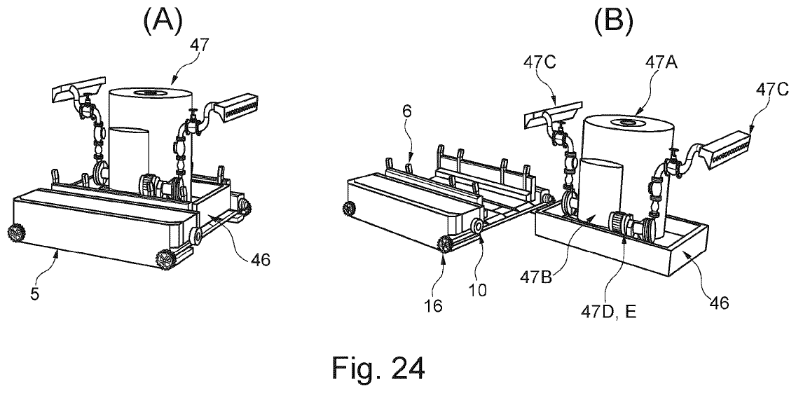

FIG. 24 shows an embodiment using the disclosure in the context of vertical farming.

FIGS. 1-3 show a storage facility 1, the storage facility 1 having a plurality of storage racks R and storage rack levels 3 for storage of load units T, wherein the storage racks R have an aisle 2 between them on one side and are placed back-to-back on the other side.

The load units T may be trays, totes, containers etc. and be of the storage type S in which product is stored so to be picked from when fulfilling orders. The load units T may also be of the order type O into which product is put or placed according to an order for fulfilling said order at least partially.

Each storage rack level having running rails 4 on the opposing faces of the storage racks R, on which at least one storage and retrieval apparatus 5 may travel the length of the aisle 2.

In the present embodiment, the load units T are stored in a double deep configuration in the storage racks R.

The storage racks have load rails 11 (or ledgers) on which the load units T are placed and that are supported between the running rails 4 on one side and longitudinal support rails 12 on the other side. The ledgers 11 are arranged perpendicular to the longitudinal extension of the rack R (or aisle 2). Two (or more) ledgers 11 support each load unit T (e. g. tray) from below. The ledgers 11 are arranged along the storage space of each rack R and level 3.

The running rails 4 and longitudinal support rails 12 are attached to uprights 13. The uprights 13 either face the aisle 2 or are located between racks R that are arranged back-to-back.

Every five (5) levels a maintenance platform 14 is arranged in the aisle 2 so that maintenance personnel may access the aisle, racks and shuttles etc. if necessary.

In the present embodiment the storage and retrieval apparatus 5 are so-called shuttles 5 having a carrying area 6 for at least one load unit T, located between load handler 7 that may extend into the storage racks R in a direction perpendicular to the length of the aisle 2, for placing or retrieval of load units T into or from the storage racks R.

Load handler 7 include telescopic rails 8 that can be extended to both sides of the carrying area 6 and have contact elements 9 that can be swiveled between an upright non-use position and a horizontal use-position, in which the contact elements 9 will contact the face of a load unit T when pushing into the racks R or pulling from the racks R or onto carrying area 6 in a known manner.

Each shuttle 5 has a first set of four traveling wheels 10 for traveling along the running rails 4 horizontally along the respective storage rack level 3 of an aisle 2. Two wheels per set on each side of the storage and retrieval apparatus 5, one or both of each side being driven by a motor via a joint driven axis.

For each aisle 2 at least two pairs of vertical climbing rails 15 (a set of vertical climbing rails) are present on opposing faces of the storage racks R adjacent the respective aisle 2. Optionally, they will be arranged at the end of the aisle.

These are implemented as uprights. The vertical climbing rails 15 may also be attached to uprights 13 in the appropriate positions.

Each shuttle 5 has a climber 16 for vertical movement along the vertical climbing rails 15 by engaging these.

The climber 16 of each shuttle 5 include a set of four climbing wheels 16 for interaction with the vertical climbing rails 15. The four climbing wheels 16 have a perpendicular axis of movement in comparison to the four travelling wheels 10. The four climbing wheels 16 are retractable between an extended engaging position for interaction with the vertical climbing rails 15 (see FIG. 2C) and a retracted non-engaging position (see FIG. 2B) while travelling horizontally along the running rails 4 horizontally along the respective storage rack level 3.

The climbing wheels 16 are each arranged at a similar position as the travelling wheels 10 on the shuttle 5, so as not to change the center of gravity etc. As can be seen in FIG. 2 they are each arranged slightly above the travelling wheels so as not to interfere with horizontal movement or center of gravity.

The climbing wheels 16 are gear wheels (pinions) and the vertical climbing rails 15 have corresponding linear gears (racks) or chains in the present embodiment.

The retraction mechanism is optionally a lever arm 20 (see for example FIG. 6) that is articulated such that the climbing wheels 16 are pressed into the linear gears or climbing rails 15 by self-weight of the shuttle 5 allowing positive interaction and climbing by driving the climbing wheel set as if they were travelling wheels. To do so the retraction mechanism connects the climbing wheels 16 to the drive motors of the travelling wheels 10 when in the extended position.

As schematically seen in FIG. 6, the lever arm 20 of the retraction mechanism is optionally hinged and driven, so as to implement a self-locking principle by self-weight of the shuttle 5, so as to stop a shuttle 5 in the event of (a power) failure from uncontrolled vertical travel or crash. To do so the climbing wheels 16 are attached by lever arm 20 to the frame of the shuttle 5 such that it implements a wedge-like function, as the hinge is higher than the wheel 16. This allows a shuttle 5 to slowly passively travel downward.

Additionally, or alternatively, the climbing wheels 16 are equipped with a mechanical failsafe brake that may be activated so as to completely stop a shuttle 5.

This allows the shuttle 5 to move up and down the climbing rails 15 as shown for example in FIG. 3A.

As can also be seen in FIG. 3A the horizontal running rails 4 need to be interrupted by a gap or space 19 on both sides of direction change rails 17 coinciding with the vertical climbing rails 15 so that the shuttle 5 can access each level 3.

Each shuttle 5 has a second set of four retractable traveling wheels 18 for traveling horizontally along the direction change rails 17 along the respective storage rack level 3 of an aisle 2 in the area of the vertical climbing rails 15. Space or gap 19 is wide enough that the traveling wheels 10 “fit through”.

Each shuttle 5 has two retractable traveling wheels 18 per set on each side; one or both of each side being driven on a joint driven axis, for use while changing the direction of movement of the shuttle 5 from a vertical movement along the vertical climbing rails 15 to a horizontal movement along the running rails 4 of a respective storage rack level 3 of an aisle 2. Therefore, the retractable traveling wheels 18 are positioned inward and lower than the “normal” traveling wheels 10.

Similar to the climbing wheels 16, the four retractable traveling wheels 18 are retractable wheels and are controlled to be extended whilst the shuttle 5 is traveling along direction change rails 17. In the extended position the traveling wheels 18 are engaged with the drive of the travelling wheels 10.

In general, this allows for the following movement. As indicated in FIG. 2B the shuttle 5 uses the travelling wheels 10 to travel horizontally along the running rails 4 in each respective level 3 in the aisle 2. For vertical travel, as indicated in FIG. 2D the shuttle 5 uses climbing wheels 16 to travel vertically along the climbing rails 15 to a respective level. During the direction change phase, as indicated in FIG. 2D, the shuttle 5 uses the traveling wheels 18 to travel along the direction change rails 17.

FIGS. 5A-E indicate how this plays out in detail.

At first the shuttle 5 contacts the vertical climbing rails 15 with its driven climbing gear wheels 16 positively allowing a climbing travel to a respective level 3 (FIG. 5A). Then the four traveling wheels 18 are extended from the retracted position to extended position so as to engage with the direction change rails 17 (see FIG. 5B).

Then the climbing gear wheels 16 are retracted and the shuttle 5 travels horizontally along the direction change rails 17 using the “second” auxiliary traveling wheels 18 (see FIG. 5C). These engage an inner flange of the rails 4 and 17, which both have an identical C-shaped cross section and are aligned. As soon as the gap 19 has been overcome, the travelling wheels 10, being further apart, engage the running rails 4 on the top flange allowing the shuttle 5 to run on the running rails 4 at the same time as using the auxiliary traveling wheels 18. In other words, the shuttle 5 is either supported by the travelling wheels 10 on the top flange forming the running rail 4 and/or by the auxiliary traveling wheels 18 on the lower inner flange forming the direction change rail 17 (see FIG. 5D). By further travel the shuttle leaves the area of the climbing rails 15 and allows travel using travelling wheels 10 in engagement with the running rails 4 only (see FIG. 5E). Then the auxiliary traveling wheels 18 may be retracted.

The retraction mechanism could be implemented in various ways. The movement of the auxiliary traveling wheels 18 into position could be implemented by a pneumatic cylinder mechanism, rack and pinion mechanism or a driven lever linkage mechanism. Also, a servo motor drive could be implemented.

Alternatively, the auxiliary traveling wheels 18 could be horizontally moved to be positioned in a vertical line below (or above) the travelling wheels 10, so that they too benefit from the gaps 19, when the shuttle 5 moves vertically. After reaching the destination level the auxiliary traveling wheels 18 could then be moved horizontally into the engaging position.

As shown in FIG. 4A, B it is possible to implement more than one set of climbing rails 15 per aisle 2. In the shown embodiment, two sets of climbing rails 15A, B are present adjacent each other in the aisle.

This allows to use one set for dedicated upward travel and the other set for dedicate downward travel, as indicated by the arrows, increasing throughput. Obviously, a second pair of two sets can be positioned at the other end of the aisle.

This also implements a redundancy, as a shuttle 5 stuck within one set may be circumvented using the other set of climbing rails 15 (as indicated by the hashed lines).

FIGS. 7-15 indicate various possibilities for implementation of racks and storage. In FIG. 7 the racks allow single deep storage of load units T being totes or containers, whereas in FIG. 8 a double deep storage of load units T is implemented. In FIG. 9 the double deep storage has stacked load units T. FIG. 10 in turn shows an implementation of a triple deep storage of load units T, whereas these are stacked in FIG. 11. As indicated in FIG. 12, the load units T may be trays, shown in a triple deep storage. It is even possible to not use aids for load units T at all, as seen in FIG. 13 showing direct placement or storage of boxes without trays or totes etc.

To allow handling of stacked load units T, the corresponding shuttle 5 may be equipped with a mechanism to selectively grip and lift load units to be able to stack and unstack load units inside the rack without necessity for leaving the aisle. Such a mechanism could e. g., grip the side walls with a certain amount of pressure with jaws or apply them laterally and lift off the load unit.

FIGS. 14 and 15 indicate different implementations of the storage itself.

In FIG. 14 two storage areas, one smaller one 1A and a larger one 1B being connected by a raised shuttle bridge 22 (by extending the running rails 4), that connects aisles 2 of both areas 1A, B allowing travel of the shuttles 5 between the areas 1A, B. This allows floor-based travel underneath the bridge 22.

In FIG. 15, the racks R have three different heights 23A, B, C along the extension of the aisle 2, for example allowing placement of the storage 1 on a hill side.

FIGS. 16 to 17 show different implementations of the storage facility in connection with order fulfilment.

In FIGS. 16A-E an embodiment using AMR 24 for transfer of a shuttle 5 between aisles 2 and/or also for ground-based transportation of load units T between a virtual GTP station 25 and the storage racks R is shown.

In FIG. 16A, the shuttle 5 drops off a on the lowest level 3 of an aisle 2 onto a discharge conveyor 26, Which is placed in extension of one side of the racks R of an aisle. A corresponding storage conveyor 27 is placed on the opposite side.

The shuttle 5 can therefore discharge a load unit T to discharge conveyor 26 or retrieve a load unit T from storage conveyor 27.

The conveyors 26, 27 are supplied or serviced by the ground-based AMR 24 having a carrying platform for a load unit T.

The AMR 24 travel back and forth between the conveyors 26, 27 and a virtual GTP station 25 being formed on-the-fly by the AMR 24 carrying load units T either being order load unit (to be picked into) or being product load units (being picked from) at the area the picker P is positioned. This may be a fixed or variable area.

Additionally, the AMR 24 my exchange load units T between aisles.

In the alternative version of FIGS. 16B-E, the shuttle 5 may also leave an aisle 2 and change aisles 2 by using a second version of AMR 28 that have a carrying platform 29 for a shuttle 5. To change the aisle 2, the AMR 28 may position itself below the climbing rails 15 (see FIG. 16C) by driving into the respective aisle. The shuttle 5 will then lower itself onto the platform 29 and retract the climbing wheels 16 (FIG. 5D).

Then the AMR 28 will leave the aisle 2 carrying the shuttle 5 and travel to its destination. Such a destination could also be a service and maintenance station.

FIG. 17 shows an embodiment similar to FIG. 16a, but using conventional conveyors 30 for load unit T transport in the pre-zone and to a physical GTP station 31.

A direct horizontal exchange of load units T may take place from one aisle 2 to an adjacent aisle 2′ via exchange locations Q within the storage racks R, wherein the shuttle 5 itself actively horizontally moves the units T in the exchange locations Q using the telescopic arms.

In addition to the climbing shuttles 5 the storage facility 1 according to FIG. 17 has a lift 32 that is present in at least one storage rack per aisle 2 and can speed up vertical transfer.

The lift 32 interfaces with the conveyor 30 of the pre-zone via discharge and storage conveyors 33, 34. The lift 32 has a conveyor platform 35 that can be raised and lowered and interfaces with buffer conveyors 36 on each level.

In FIG. 18A, B an embodiment using a flow rack as a GTP 37 along the length of an outside of a respective storage is shown. The shuttle 5 can supply the flow rack from the aisle 2 behind it by pushing load units through, similar to the operation of the exchange locations Q above. The GTP 37 has two slanted rows 38 of presentation spaces sourced by the flow rack and positioned above each other. Below them is a discharge conveyor 39 to transport picked load units to a packing area.

As indicated by the arrows, the material flow may be “circular”, using climbing rails 15 on one side of the storage or aisles 2 for upward travel, the climbing rails 15 on the other side of the storage or aisles 2 for downward travel and the upper levels 3 for travel from the upward to the downward climbing rails and the lower levels for the opposite direction.

FIG. 19 shows a rescue operation of a shuttle 5B that has broken down in the aisle 2, somewhere on the running rails 4. It can be rescued by a second shuttle 5A that can be controlled to push the shuttle 5B to the end of the aisle 2 where it can be more easily accessed.

To do so the shuttles 5A include a set of bumpers 40 facing the direction of movement along the aisle 2 for contacting the surface 41 of the front respective back housing of the shuttle 5B, or alternatively a respective pair of bumpers 40 of the second shuttle 5B, allowing a pushing operation.

The bumpers 40 may be positioned on the surface 41 of the front respective back housing of the shuttle 5A, B or alternatively on the climbing wheels 16′ depending on their placement.

FIG. 20 shows an embodiment having shuttles 5 (as above) and robotic picking shuttles 42 as well as having cross aisle running rails 43 forming a bridge perpendicular to aisle 2 direction for movement of shuttles 5 between aisles 2 propelled by the set of the climbing wheels 16.

The robotic picking shuttles 42 will have all the features of a climbing shuttle 5 and additionally have a robotic picking device 44 and a vision system 45 for identifying the respective item to be picked. The robotic picking shuttles 42 will carry an order load unit that they pick into using the robotic picking device 44 and the vision system 45, without leaving the rack R. The product load unit will be presented in the aisle by a climbing shuttle 5.

FIG. 21 shows an implementation of a removable maintenance platform 14 (FIG. 21A) that is adapted to be brought into place for accessing the area between the vertical climbing rails 15. Obviously this area cannot be constantly accessible by a fixed maintenance platform.

The maintenance platform 14 is shown in two alternatives. Both have an extendable grating-based platform 14A that is extendable by an extension platform 14B that is either slidable or swivable for the extension (see FIG. 21B), to achieve the extended access to the area between the vertical climbing rails 15.

FIGS. 22-24 show an embodiment in the context of vertical farming. In this context, the storage is similar to that of FIG. 16A, with the difference that the load units are special trays 46 (see FIG. 23A, B, C) that carry plants, and that the shuttle 5 carry special plant maintenance load units 47.

The racks R support the trays 46, similar to normal load units T, and will feature a light source etc. for the plants to grow. The trays 46 can either hold a boxlike open insert 46A for directly holding soil or growth medium, an insert 46B having openings 48A arranged in a grid for holding planting pots 48B, or a compartmented insert 46C providing multiple compartments for directly holding a plant each.

As detailed in FIG. 24, the special plant maintenance load units 47 may also be transported in trays 46. The plant maintenance load units 47 will contain a water tank 47A, a pump 47B, two water dispensers 47C (one on each side to water plants on either side of the aisle), an electrical energy source 47D (battery, capacitors etc.) and a controller 47E etc. The water dispensers 47C may be implemented to be adjustable, like a robotic arm.

In this way, shuttles 5 may transport the plant maintenance load units 47 through the rack R and water irrigate the plants. The water may contain fertilizer, insecticide etc. Shuttle 5 may also relocate, discharge or store trays 46 with plants as necessary.

In any of the embodiments, at least one of the vertical rails 15 may include a power charging line adapted to connect to a power charging take-up on the shuttle 5 to allow charging of an onboard battery or capacitor. Additionally, shuttle 5 may contain a recuperation device connected to the climbing wheels to recover energy while moving downwards.

1. A storage facility comprising:
a plurality of storage racks and storage rack levels for storage of load units, wherein two storage racks have an aisle between them;
each storage rack level having running rails on the opposing faces of the storage racks, on which at least one storage and retrieval apparatus may travel the length of the aisle, for each aisle at least two pairs of vertical climbing rails on the opposing faces of the storage racks adjacent the respective aisle;
the storage and retrieval apparatus having a carrying area, for at least one load unit, located between load handler that may extend into the storage racks in a direction perpendicular to the length of the aisle, for placing or retrieval of load units into or from the storage racks,
each storage and retrieval apparatus having a first set of four traveling wheels for traveling along the running rails horizontally along the respective storage rack level of an aisle; two wheels per set on each side of the storage and retrieval apparatus, one or both of each side being driven on a joint driven axis,
wherein
each storage and retrieval apparatus has climber for vertical movement, especially along the vertical climbing rails.

2. The storage facility according to claim 1, wherein the climber of each storage and retrieval apparatus includes a set of four climbing wheels for interaction with the vertical climbing rails, the four climbing wheels having a perpendicular axis of movement in comparison to the four travelling wheels and the four climbing wheels being retractable between an extended engaging position for interaction with the vertical climbing rails and a retracted non-engaging position while travelling horizontally along the running rails horizontally along the respective storage rack level.

3. The storage facility according to claim 1, wherein in that each storage and retrieval apparatus has a second set of, preferably retractable, four traveling wheels for traveling along direction change rails horizontally along the respective storage rack level of an aisle in the area of the vertical rails, two wheels per set on each side of the storage and retrieval apparatus, one or both of each side being driven on a joint driven axis, for use while changing the direction of movement of the storage and retrieval apparatus from a vertical movement along the vertical climbing rails to a horizontal movement along the running rails of a respective storage rack level of an aisle.

4. The storage facility according to claim 3, wherein the four traveling wheels for traveling along direction change rails horizontally along the respective storage rack level of an aisle in the area of the vertical rails are retractable wheels and are controlled to be extracted whilst the storage and retrieval apparatus is traveling along direction change rails.

5. The storage facility according to claim 1, wherein the direction change rails are arranged between the vertical climbing rails on each level having running rails and in that the running rails of a respective storage rack level of an aisle have a gap to the direction change rails horizontally along the respective storage rack level of an aisle in the area of the respective vertical rail.

6. The storage facility according to a claim 1, wherein cross aisle running rails form a bridge perpendicular to aisle direction for movement of each storage and retrieval apparatus between aisles, propelled by the set of four climbing wheels.

7. The storage facility according to claim 1, wherein the climbing wheels are gear wheels (pinion) and the vertical rails and/or cross aisle running rails have corresponding linear gears (racks) or chains.

8. The storage facility according to claim 1, wherein a direct horizontal exchange of load units takes place from one aisle to an adjacent aisle via exchange locations within the storage racks, wherein the storage and retrieval apparatus itself actively horizontally moves the transportation units in the exchange locations using the load handler, such as telescopic arms having engageable load contacting means.

9. The storage facility according to a claim 1, wherein the rack has an interface to conveyors of the pre-zone or front zone of a fulfilment area for connection to picking stations anywhere between the lowest level to highest level, preferable at least one per aisle.

10. The storage facility according to claim 1, wherein the storage rack has at least one interface allowing hand over of load units to an AMR (Autonomous Mobile Robot) for further ground-based transportation.

11. The storage facility according to claim 1, wherein the facility includes a ground-based transportation AMR implemented to allow transportation of a storage and retrieval apparatus within the storage, preferably between aisles.

12. The storage facility according to claim 1, wherein the facility includes a storage and retrieval apparatus implemented with a stacker to stack and unstack load units on top of each other on its carrying area.

13. The storage facility according to claim 1, further comprising a lift is in at least one storage rack per aisle.

14. The storage facility according to a claim 1, wherein more than one storage and retrieval apparatus can be inducted into a single level.

15. The storage facility according to a claim 1, wherein the storage and retrieval apparatus include a set of bumpers facing the direction of movement along the aisle for contacting a respective pair of bumpers of a second storage and retrieval apparatus allowing a pushing operation.

16. The storage facility according to any claim 2, wherein the retraction mechanism of the climbing wheels contains a self-locking principle, especially by a lever arm that is articulated such that the climbing wheels are pressed into the climbing rails by self-weight of the storage and retrieval apparatus allowing positive interaction and climbing by driving the climbing wheel set as if they were travelling wheels.

17. The storage facility according to claim 16, wherein the lever arm of the retraction mechanism is preferably hinged and driven so as to stop a storage and retrieval apparatus in the event of (a power) failure from uncontrolled vertical travel or crash, optionally the climbing wheels are attached by lever arm to the frame of the storage and retrieval apparatus such that it implements a wedge-like function.
